(19) United States
(12) Patent Application Publication
(10) Pub. No.: US 2010/0144944 A1
(43) Pub. Date: Jun. 10, 2010

(54) JOINT FILLING COMPOSITION

(75) Inventors: Gerald J. GUERRO, Hopewell Junction, NY (US); John J. DOHERTY, Fishkill, NY (US)

Correspondence Address: HESLIN ROTHENBERG FARLEY & MESITI PC, 5 COLUMBIA CIRCLE, ALBANY, NY, 12203, US

(73) Assignee: PACKAGE PAVEMENT CO., INC., Stormville, NY (US)

(21) Appl. No.: 12/328,919

(22) Filed: Dec. 5, 2008

(51) Int. Cl. C08K 3/38

(52) U.S. Cl. 524/405

(57) ABSTRACT

The present invention provides compositions used for filling joints in construction applications that remain hard yet pliable over time, even in gaps larger than 1.2 centimeters and methods of making the same.

### BACKGROUND OF THE INVENTION

1. Field of the Invention

The present invention relates to filling joints in construction related applications. More specifically, the invention relates to filling joints such as those between pavers and/or stone with a durable and hard, yet pliable filling composition.

2. Description of Related Art

In the field of civil engineering, there is a need for continuous maintenance of materials used to fill the spaces between paver blocks or stone typically used for walkways and patios. Typically, the spaces separating the pavers' vertical contact walls may be filled with sand. The sand acts as a shock absorbing material when the pavers are subjected to lateral forces applied by rolling vehicles as they pass across its surface, it also prevents the pavers from coming loose from their abutment.

One common problem with the use of sand as a “joint filler” for the spaces between interlocking pavers, is that being very fine in mesh and light in weight, the sand is prone to erosion out of the interstitial spaces of the pavers by the action of wind, water runoff, rain and general settling due to random load changes on the pavers in their day-to-day use.

Previous attempts to solve this problem have resulted in joint fillers which have drawbacks. For example, joint fillers, which are sufficiently hard, are not sufficiently pliable and thus are susceptible to cracking. However, joint fillers which are pliable after application, typically do not remain pliable and flexible under various environmental temperature ranges, or if sufficiently pliable, are not sufficiently hard enough, particularly to fill large joints, namely, 1.2 centimeters or wider. Moreover, joint fillers often crumble back to a powder at some point after installation and activation. In addition, joint fillers may also require special physical conditions such as a particular humidity range in order to maintain their flexibility and pliability. Finally, large or costly equipment may be necessary in order to mix the constituents thoroughly, or requiring expensive ingredients.

One joint filler that is commonly used is some form of polymeric sand. Polymeric sands are typically a mixture of graded sand and a polymeric binder material which acts as a water storage component. Polymeric sands retain effective resilience and pliability, but suffer from low hardness upon exposure to water and are susceptible to being washed out of joints over time. These compounds also tend to become soft during periods of high humidity.

Another joint filling compound is described in U.S. Patent Publication No. 2008/0050176 which discloses sand and a cross linking material and a water storage component in order to allow the composition to resist water erosion. However, such a joint filler does not achieve a hardness sufficient for many situations. Specifically, the composition is too soft particularly when exposed to water to properly resist high pressures associated with, for example, high-heeled shoes or furniture legs. When used in patios or other high traffic areas, such a joint filler is prone to puncture, and thus is not suitable for large joint gaps, i.e., greater than 1.2 centimeters. This is common when, for example, larger stones or pavers are used which require larger joint gaps. Current joint fillers, including those described above, are too soft, particularly when wet, to efficiently bind gaps of this large size and issues with high-heeled shoes and furniture legs are likely to result if they are used. Thus, there is a need in the industry for a composition which can provide a long-lasting flexible joint filler for aggregate materials such as stone or pavers for construction related applications that are durable, pliable, and sufficiently hard so as to be capable of binding and locking joint spaces larger than 1.2 centimeters, and even up to 8 centimeters.

### SUMMARY OF THE INVENTION

In one aspect, the invention is a hard yet pliable joint filler composition comprising polyvinyl alcohol (PVA), a borate salt, and at least one particulate filler. The composition is also substantially free of additional materials which may act as a water storage component. The particulate filler used is, for example, either sand or stone dust. The borate salt used may be sodium borate and may be in the form of the decahydrate.

For example, the amount of PVA used is generally more than 1 percent by weight of the particulate filler, and may be between 1 and 10 percent by weight of the particulate filler, and between 3 and 7 percent, by weight, of the particulate filter. The amount of borate salt is generally ten percent or more of the particulate filler, and may be between 10 and 25 percent by weight. Also, for example, the amount of borate salt used is at least about 10 percent by weight of the polyvinyl alcohol.

Preferably, the PVA has a molecular weight of between 7,000 Daltons and 23,000 Daltons. In addition, the PVA is preferably between 87% and 99% hydrolyzed. The PVA may also have a viscosity rating of between 3.5 and 6.2 centipoises in a 4% solution at 20° C. In yet another embodiment, the PVA has a degree of polymerization of between about 150 and about 650.

In another aspect, the invention yields a joint filling composition having a shore “A” wet hardness rating of 40 or higher; a shore “A” wet hardness rating of 50 or higher; and/or a shore “A” wet hardness rating of 60 or higher.

In yet another aspect, the invention provides methods for making a joint filling compound that is substantially water storage component free by combining one or more particulate fillers with PVA, and a borate salt.

The present invention can be used to fill joints larger than 1.2 centimeters, and provides a method of use for filling joints larger than 1.2 centimeters. The joint filler may be used to fill joints of up to about 8 centimeters. The joint filler wherein said composition forms a material which filled within joint gaps of 1.2 centimeters or larger and saturated with water and allowed to dry, remains intact when exposed to water and weather thereafter.

The present invention provides several advantages over the joint filling compositions of the prior art. First, the present invention results in joints that are much harder than many current joint fillers, particularly when exposed to water. Second, the present joint filling composition is capable of securely binding joints larger than 1.2 centimeters. In the current market environment, larger and larger joints are being used as aesthetic and functional requirements change. As such, a joint compound is required that will securely bind the stones, pavers, etc together while maintaining physical integrity under varied environmental conditions. Current standard joint fillers, such as polymeric sand, are unacceptable because they are susceptible to water and wind erosion.

These and other features, aspects, and advantages of the present invention will become better understood with reference to the following description, examples, and appended claims.

### DETAILED DESCRIPTION OF THE INVENTION

The present invention provides a substantially water storage component free joint filling composition and methods for making and using the same. More specifically, the present invention comprises a joint filling composition made up of polyvinyl alcohol, one or more borate salts, and one or more particulate fillers for use in filling joints in construction applications, and is substantially free of additional materials which act as a water storage component. The joint filling compositions described herein are able to remain hard yet pliable in a variety of applications, including use in gaps larger than 1.2 centimeters. The joint filler composition is capable of forming a joint, which is of sufficient hardness, but will not crumble. The joint is capable of withstanding significant erosion so as to remain intact when exposed to water, wind and rain.

In accordance with the principles of the present invention the joint filler composition is substantially free of a water storage component. The term “substantially free”, as used herein, is achieved when the amount of water storage component is nonexistent or sufficiently low so that the shore “A” wet hardness of the joint (measured at between 3 and 6 minutes after saturation with water) is about 40 or higher. Joint filler compositions having a water storage component present in an amount of one percent or more by weight of the composition, generally are not substantially free of a water storage component and thus are outside the scope of the invention.

The term “water storage component” or “water storage material” is used herein to refer to a group of materials which store and slowly release water. Such materials include colloidal polysaccharides and various types of hygroscopic polymers. Mucilages belong to a class of colloidal polysaccharides and are produced by, and extracted from, certain plants. Plants containing mucilage include: quince seeds, flax seed, konjac glucomannan, guar gum, locust bean gum, carob bean gum, aloe acemannan, xanthan gum, psyllium seed, carrageanan, and gum arabic. Other materials that are water storage components include: agarose, amylopectins, amyloses, arabinans, arabinogalactans, arabinoxylens, carageenans, gum Arabic, carboxymethyl guar gum, carboxymethyl(hydroxypropl) guar gum, hydroxyethyl guar gum, carboxymethyl cellulose, cationic guar gum, cellulose ethers including methyl cellulose, chondroitins, chitins, chitosan, chitosan pyrrolidone carboxylate, chitosan glycolate, chitosan lactate, cocodimonium hydroxypropyl oxyethyl cellulose, colominic acid (poly-[N-acetyl-neuroaminic acid]), corn starch, curdlan, dermatin sulfate, dextrans, cross-linked dextrans, furcellarans, dextrin, emulsan, ethyl hydroxyethyl cellulose, galactoglucomannans, galactomannans, glucomannans, glycogens, hydroxyethyl starch, hydroxypropyl methyl cellulose, hydroxyethyl cellulose, hydroxypropyl cellulose, hydroxypropyl starch, hydroxypropylated guar gums, gellan gum, gellan, gum ghatti, gum karaya, gum tragancanth, heparin, hyaluronic acid, inulin, keratin sulfate, modified starches, laminarans, laurdimonium hydroxypropyl oxymethyl cellulose, okra gum, oxidized starch, pectic acids, pectin, polydextrose, polyquaternium-4, polyquaternium-10, polyquaternium-28, potato starch, protopectins, pullulan, sodium hyaluronate, starch diethylaminoethyl ether, steardimonium hydroxyethyl cellulose, raffinose, rhamsan, tapioca starch, whelan, levan, scleroglucan, sodium alginate, stachylose, succinoglycan, wheat starch, xylans, xyloglucans, hygroscopic polymers, and mixtures thereof Khakha, which is recognized in the construction industry as a water storage component containing psyllium is typically mixed with a particulate and the mixture used as a joint filler.

The term “polyvinyl alcohol” is used in its broadest sense to include solid organic compounds having at least two hydroxyl groups in the form —CH₂—CH(—OH)—. In some embodiments of the present invention, the PVA has an average molecular weight between 7,000 daltons and 23,000 daltons. In other embodiments, the PVA is between 87%-99% hydrolyzed. In still other embodiments, the PVA has a viscosity rating of between 3.5 and 6.2 centipoises in a 4% solution at 20° C. In still other embodiments, the PVA has a degree of polymerization of between about 150 and about 650.

Polyvinyl alcohol (PVA) is a polymer composed of a long hydrocarbon chain with hydroxyl groups attached at every other carbon, and it is often used in industrial applications. PVA is highly susceptible to hydrogen bonding when in an aqueous solution, increasing its interaction with water and allowing for greater solubility as compared to polyethylene. If PVA is present in water in high concentrations, PVA molecules will interact so as to make a viscous solution. When large amounts of water are present, PVA has a tendency to form link chains of up to 2,000 units and not engage in hydrogen bonding, resulting in a non-viscous solution.

Borates are widely used in industrial applications in the form of boric acid and borax. Borax, or sodium borate is a white, anhydrous crystalline salt that is used in the manufacturing of soap glass, enamel, and artificial gems. Borax and other borate salts are capable of acting as cross-linking materials with PVA in an aqueous solution. The cross linking is such that, in the proper proportions, a very hard yet pliable solid is formed upon the addition of a particulate filler, saturation with water, and an appropriate curing time.

The term “borate salt” includes sodium metaborate, sodium tetraborate, hydrated sodium borate, hydrated sodium metaborate, and hydrated sodium tetraborate. In some embodiments, the borate salt is the sodium borate, and in still other embodiments, the sodium borate is of the decahydrate form.

The term “particulate fillers” is understood by those skilled in the art, and includes sand and stone dust.

An embodiment of the present invention will be formed by dry mixtures of: a) about 1% to about 10% PVA, by weight of the particulate filler, preferably between 3% and 7%, and more preferably between 5 and 7%; b) at least about 10% by weight of the PVA of a borate salt, preferably between about 10% to about 15%; and c) the balance of the composition generally being particulate filler, preferably sand or stone dust.

In general, the joint filling composition is used by mixing the PVA, a borate salt, and a particulate filler. The resilient composition is then swept into a joint, for example, between pavers or stone, in a walkway or patio. Once the joint is filled to the desired level, the composition is saturated with water and then allowed to harden. Typically, the joint hardens sufficiently in about three days. The described composition can be used effectively in joints larger than 1.2 centimeters, which is an advance over the current state of the art. When the joint filler is applied to the joints and fully saturated with water, the reaction of the borate salt and PVA results in crosslinking of the PVA. However, if a separate water storage component or material is present with the PVA, particulate and borate salt, the composition will retain water and soften. Accordingly, in order to maintain a sufficiently hard joint, little or no water storage component should be mixed with the particulate, PVA and borate salt.

The amount of polyvinyl alcohol useable in the present invention varies. Preferably, the amount of polyvinyl alcohol should be greater than 3% by weight of the particulate filler. Optimum results are achieved in accordance with the principles of the present invention when the amount of polyvinyl alcohol is between 3 and 7% by weight of the particulate filler. Although more than 7% by weight of polyvinyl alcohol may be used, improved joint performance is generally limited or not significant. In addition, the amount of borate salt useable with the present invention is dependent by weight upon the amount of polyvinyl alcohol used. Accordingly, use of more than 7% by weight of polyvinyl alcohol will require use of more borate salt.

The amount of borate salt useable in the joint filler in accordance with the present invention is dependent upon the amount of polyvinyl alcohol used. Generally, the amount of borate salt useable should be at least 10% or more by weight of polyvinyl alcohol. However, optimum results are achieved when the amount of borate salt is between 10 and 15% by weight of polyvinyl alcohol. Although more than 15% of borate salt may be used, such additional amounts generally do not result in a significant improvement in joint performance. In accordance with the principles of the present invention, optimum results for the joint filler composition are achieved when the amount of polyvinyl alcohol is between 3 and 7% by weight of the particulate filler, and the amount of borate salt is between 10 and 15% by weight of the polyvinyl alcohol. Furthermore, when the particulate filler comprises stone dust, the optimum amount of polyvinyl alcohol useable with the present invention is between about 3 and 5% by weight of the particulate filler. When the particulate filler comprises sand, optimum results are achieved when the amount of polyvinyl alcohol is between 5 and 7% by weight of the particulate sand filler.

An embodiment of the joint filler suitable for wide joints of larger than 1.2 centimeters or 1/2 inch may be formulated in 70 pound bags of joint filler composition. Each 70 pound bag contains 96.81% by weight of stone dust, 2.90% by weight of Celvol® 205S polyvinyl alcohol available from Celanese Corporation, and .29% by weight sodium borate decahydrate. These amounts, by weight, correspond to Celvol® 205S in the amount of 3% of the weight of stone dust, and sodium borate decahydrate in an amount of 10% the weight of Celvol® 205S. Celvol® 205S comprises a polyvinyl alcohol of fine particle grade, 81.0% -89.0% hydrolysis, 5.2-6.2 centipoises viscosity at 4% aqueous solution and 20° C., and a ph of 4.5-65 at 4% aqueous solution. The joint filler composition may be made in bulk in 1.5 ton amounts. In such amounts, 2904.3 pounds of stone dust are mixed with 87 pounds of Celvol® 205S and 8.7 pounds of sodium borate decahydrate.

The above disclosure describes several embodiments of the invention. The skilled artisan will recognize that other embodiments of this invention, which are not overtly disclosed, may be employed in the practice of this invention. The invention is further illustrated by the following non-limiting examples, wherein all parts are parts by weight unless otherwise specified.

### EXAMPLES

### Example 1

In this test, 6% by weight Celvol® 205S polyvinyl alcohol (PVA) was mixed with sand, along with the addition of specific amounts of sodium borate, from 0% to 68.2% by weight of PVA. The mixtures were distributed into 0.5 inch joints, saturated with water, and tested using the Shore “A” hardness test at 3 minutes and 6 minutes post-saturation. Sand/Khakha was used as a control in this series of experiments. The data from this test is shown in table 1. Examples were categorized as “excellent” if the average Shore “A” rating at 3 minutes and 6 minutes after saturation was 40 or higher, “marginal” if the average was between about 25-about 37, and “poor” if lower than about 25. Multiple joint fillers were used in joints of ½ inch and the results shown in the chart below. Borate was added as a percentage of Celvol® 205S polyvinyl alcohol. A control joint filler comprising sand (with Khakha), commonly known as Brownstone Joint Lock® was also tested. The amount of Celvol PVA was present at 6% by weight of the particulate for all joint fillers, except the control. The amount of borate was varied up to 68.2% by weight of Celvol.

TABLE 1
Effect of Borate Catalyst on Composition Hardness

| | “Dry” | “Wet” Shore | “Wet” Shore | |
|---|---|---|---|---|
| Description | Shore A | A (3 min) | A (6 min) | Remarks |
| Sand/PVA | 44 | 23 | 1 | Poor |
| no borate | | | | |
| Sand/PVA/1.36% | 34 | 29 | 26 | Marginal |
| Sodium Borate | | | | |
| Sand/PVA/4.09% | 54 | 49 | 24 | Marginal |
| Sodium Borate | | | | |
| Sand/PVA/15% | 58 | 43 | 39 | Excellent |
| Sodium Borate | | | | |
| Sand/PVA/68.2% | 55 | 46 | 52 | Excellent |
| Sodium Borate | | | | |
| Sand/Khakha | 40 | 3 | 1 | Poor |

### Example 2

In this test, specific amounts of Celvol® 205S polyvinyl alcohol (PVA) were combined with sand, and this mixture was then combined with varying amounts of sodium borate. The amount of PVA used is expressed as a percent of weight of the particulate filler. The resultant composition was then distributed into 0.5 inch joints, saturated with water, and tested using the Shore “A” hardness test at 3 minutes and 6 minutes post-saturation. The data from this test is shown in table 2. Examples were categorized as “excellent” if the average Shore A rating at 3 minutes and 6 minutes after saturation was 40 or higher, “marginal” if the average was between about 25-about 37, and “poor” if lower than about 25. Test results are for 0.5 inch joints using Celvol® 205S PVA as the filler material (with and without borate as the catalyst).

TABLE 2
Effect of Polyvinyl Alcohol Concentration on Composition
Hardness

| | Sodium Borate | “Dry” | “Wet” | “Wet” | |
|---|---|---|---|---|---|
| | (by weight | Shore | Shore | Shore A | |
| Description | of PVA) | A | A (3 min) | (6 min) | Remarks |
| Sand/ | None | 44 | 23 | 1 | Poor |
| 6% PVA | | | | | |
| Sand/ | 3% | 52 | 34 | 19 | Marginal |
| 1.47% PVA | | | | | |
| Sand/ | 10% | 55 | 48 | 29 | Marginal |
| 1.47% PVA | | | | | |
| Sand/ | 10% | 57 | 49 | 44 | Excellent |
| 5% PVA | | | | | |
| Sand/ | 10% | 60 | 43 | 41 | Excellent |
| 7% PVA | | | | | |
| Sand/ | 15% | 63 | 58 | 61 | Excellent |
| 7% PVA | | | | | |

A joint filler material which has a Shore “A” hardness of about 40 (“Wet” after 6 minutes) will generally be suitable for large joint widths. When the Shore hardness level is about 40 and higher, a much greater force is necessary to actually push a blunt typed instrument into a joint (if at all). Thus, joints of a Shore “A” wet hardness of about 40 and higher will be suitable for large joint applications, such as joints of 1.2 centimeters or higher. The invention is useable to fill joints of greater than 1.2 centimeters, greater than 2 centimeters, greater than 3 centimeters, greater than 4 centimeters, greater than 5 centimeters, greater than 6 centimeters, greater than 7 centimeters, and up to about 8 centimeters.

### Example 3

A preformed, load bearing test area was made to evaluate pavers and polymeric, jointing compounds. The pavers were aligned to a controlled joint, and the polymeric high performance joint material was then swept into joints between the pavers. Excess jointing sand was then removed, and the surface was sprayed with water to soak the material thoroughly. In this test, the water was allowed to harden for 3 days, then tested in the following manner.

Water (from a garden hose) was directed onto the paver at full spray. The overflow of this water was redirected onto the surface of the joint allowing for total immersion of the jointing material (to simulate swimming pool areas). As a control, a standard Joint Lock® product, which is a polymeric sand made using sand and a water storage component, namely, Khakha, was used as a test comparative. Following 5 minutes of full water spray, the hose was then directed at the joint itself. Results are recorded in the table below. All joints were ½ inch in width.

TABLE 3
Effect of Joint Tenacity on High Performing Joint Sand (using
PVOH and Borate)

| | % | % | High Spray | High Spray |
|---|---|---|---|---|
| | Celvol | Sodium | on Paver | on Joint |
| Description | 205S | Borate | (10 min) | (8 min) |
| Joint Lock | n/a | n/a | Jointing material | Jointing material |
| Paving Sand | | | eroding | removed from |
| (control) | | | | Joint completely |
| Exp A | 1 | 0 | Erodes quickly | Completely |
| (Sand) | | | | removed |
| Exp B | 3 | 10 | Softening | Completely |
| (Sand) | | | | removed |
| Exp C | 4.5 | 12 | Softening | Partial removed |
| (Sand) | | | | |
| Exp D | 6 | 15 | Slight Softening | Joint in tact |
| (Sand) | | | | |
| EXP E | 6 | 15 | Hard | Joint in tact |
| (Stone Dust) | | | | |
| EXP F | 8 | 22 | Very Slight | Joint in tact |
| (Sand) | | | Softening | |

In this next experiment, the joint filler material (mixed with mason sand) in accordance with the present invention was added to pavers in which the joint gap varied. A preformed load bearing test area was made to evaluate pavers and jointing compounds. The pavers were aligned to provide varying controlled joints, and the joint filler was then swept into joints between the pavers. Excess joint filler was then removed, and the surface was sprayed with water to soak the joint filler thoroughly. In this test, the joint was allowed to harden for 3 days, then tested in the following manner.

(A) Joint hardness was measured using a Shore Hardness instrument (Harteprufer DIN 53 505), TYPE A. The joints were tested in both wet and dry form. To measure a “wet” joint, the pavers (and joints) were lightly sprayed until full saturation occurred (this was about 3 minutes). Hardness measurements followed thereafter. The following results were recorded in the table below. For all examples below, the percentage of Celvol® 205S is based upon the weight of particulate filler, and the borate as a percentage by weight of Celvol® 205S

### Example 4

Effect of Varied Joints and Hardness Thereof for ¼ inch Joints

| Description | Joint Width | “Dry” Shore A | “Wet” Shore A |
|---|---|---|---|
| Joint Lock | ¼ inch | 43 | 15 |
| Paving sand | | | |
| Control | | | |
| 1.5% Celvol | ¼ inch | 63 | 58 |
| 10.3% Borate | | | |
| 5.0% Celvol | ¼ inch | 64 | 61 |
| 9.96% Borate | | | |
| 7.0% Celvol | ¼ inch | 75 | 65 |
| 10.06% Borate | | | |
| 7.0% Celvol | ¼ inch | 78 | 69 |
| 15% Borate | | | |

### Example 5

Effect of Varied Joints and hardness thereof for ½ inch Joints

| Description | Joint Width | “Dry” Shore A | “Wet” Shore A |
|---|---|---|---|
| Joint Lock | ½ inch | 34 | 23 |
| Paving Sand | | | |
| Control | | | |
| 1.5% Celvol | ½ inch | 66 | 60 |
| 10.3% Borate | | | |
| 5.0% Celvol | ½ inch | 68 | 52 |
| 9.96% Borate | | | |
| 7.0% Celvol | ½ inch | 68 | 43 |
| 10.06% Borate | | | |
| 7.0% Cevol | ½ inch | 73 | 66 |
| 15% Borate | | | |

### Example 6

Effect of Varied Joints and hardness thereof for 1-inch Joints

| Description | Joint Width | “Dry” Shore A | “Wet” Shore A |
|---|---|---|---|
| Joint Lock | 1 inch | 45 | 8 |
| Paving Sand | | | |
| Control | | | |
| 1.5% Celvol | 1 inch | 62 | 49 |
| 10.3% Borate | | | |
| 5.0% Celvol | 1 inch | 66 | 52 |
| 9.96% Borate | | | |
| 7.0% Celvol | 1 inch | 58 | 63 |
| 10.06% Borate | | | |
| 7.0% Cevol | 1 inch | 67 | 60 |
| 15% Borate | | | |

### Example 7

Effect of Joints and hardness thereof for 2-inch Joints

| Description | Joint Width | “Dry” Shore A | “Wet” Shore A |
|---|---|---|---|
| Joint Lock | 2 inch | 49 | 9 |
| Paving Sand | | | |
| Control | | | |
| 1.5% Celvol | 2 inch | 72 | 60 |
| 10.3% Borate | | | |
| 5.0% Celvol | 2 inch | 65 | 74 |
| 9.96% Borate | | | |
| 7.0% Celvol | 2 inch | 60 | 60 |
| 10.06% Borate | | | |
| 7.0% Cevol | 2 inch | 73 | 67 |
| 15% Borate | | | |

As can be seen from the above Examples, the joint filler, in accordance with the present invention, yields a joint of sufficient hardness for wide joints including joints of greater than ½ inch, 1 inch and 2 inches. However, the joint filler may be used for even larger joints of up to 3 inches.

In accordance with the principles of the present invention, the joint filler composition should maintain significant hardness even when exposed to large amounts of water. The present invention shows that in the presence of a crosslinking agent, such as a borate salt, PVA can suspend aggregate material and form a resilient solid even when exposed to large amounts of water. The present invention further shows that these components can be used to form a joint filling composition capable of long-term resilience in the absence of a water storage component and can be combined such that the resulting solid is able to maintain significant hardness in joints larger than 1.2 centimeters. The absence of a separate water storage component allows the joint filler to remain sufficiently hard, and thus suitable for use in large joint. Conversely, use of a water storage component would allow water to infiltrate and remain within the joint over an extended period of time, resulting in a joint of insufficient hardness, particularly if greater than 1.2 centimeters wide and wet.

While the invention is described in connection with the embodiments described herein, the invention is not limited to any particular embodiment disclosed. Modifications and variations may be made to the embodiments described herein without departing from the scope of the invention set forth in the following claims.

1. A joint filler composition comprising:
a dry mixture containing at least one particulate filler;
polyvinyl alcohol in an amount between about 1 and 10 percent by weight of said particulate filler; and
a borate salt in an amount of at least about 10 percent by weight of said polyvinyl alcohol;
wherein the balance of said composition is said particulate filler, and said composition is substantially free of water storage materials.

2. The joint filler composition of claim 1 wherein said composition yields a shore “A” wet hardness of at least about 40.

3. The joint filler composition of claim 2 wherein said composition forms a material which filled within joint gaps of ½ inch or larger and saturated with water and allowed to dry, remains intact when exposed to water thereafter.

4. The joint filler composition of claim 3 wherein said composition yields a shore “A” wet hardness of at least about 50.

5. The joint filler composition of claim 4 wherein said composition yields a shore “A” wet hardness of at least about 60.

6. The joint filler composition of claim 1 wherein said polyvinyl alcohol is present in an amount of more than about 3 percent by weight of said particulate filler.

7. The joint filler composition of claim 1 wherein said polyvinyl alcohol is present in an amount of more than about 5 percent by weight of said particulate filler.

8. The joint filler composition of claim 1 wherein said polyvinyl alcohol is present in an amount of between about 3 and about 7 percent by weight of said particulate filler.

9. The joint filler composition of claim 1, wherein said borate salt is present in an amount of between about 10 and 15 percent by weight of said polyvinyl alcohol.

10. The joint filler composition of claim 1, wherein the borate salt is sodium borate decahydrate.

11. The joint filler composition of claim 1, wherein the particulate filler is selected from the group consisting of sand and stone dust.

12. The joint filler composition of claim 1 wherein the polyvinyl alcohol has an average molecular weight between 7,000 daltons and 23,000 daltons.

13. The joint filler composition of claim 1 wherein the polyvinyl alcohol is between 87% and about 99% hydrolyzed.

14. The joint filler composition of claim 1 wherein the polyvinyl alcohol has a viscosity rating between 3.5 and 6.2 centipoises in a 4% solution at 20° C.

15. The joint filler composition of claim 1 wherein the polyvinyl alcohol has a degree of polymerization between about 150 and about 650.

16. A joint filler composition comprising:
a dry mixture containing at least one particulate filler selected from the group consisting of sand and stone dust;
polyvinyl alcohol in an amount between about 3 and 7 percent by weight of said particulate filler; and
a borate salt in an amount of at least about 10 percent by weight of said polyvinyl alcohol;
wherein the balance of said composition is said particulate filler, and said composition is substantially free of water storage materials.

17. The joint filler composition of claim 16 wherein said particulate filler comprises sand, and said polyvinyl alcohol is present in an amount between about 5 and 7 percent by weight of said sand.

18. The joint filler composition of claim 16 wherein said particulate filler comprises stone dust, and said polyvinyl alcohol is present in an amount between about 3 and 5 percent by weight of said stone dust.

19. A method for producing a joint filler composition comprising:
providing at least one particulate filler;
adding polyvinyl alcohol in an amount between about 1 and 10 percent by weight of said particulate filler; and
adding a borate salt in an amount of at least about 10 percent by weight of said polyvinyl alcohol;
wherein the balance of said composition is said particulate filler, and said composition is a dry mixture that is substantially free of water storage materials.

20. The method of claim 19 wherein said composition yields a shore “A” wet hardness of at least about 40.

21. The method of claim 20 wherein said composition filled within joint gaps of ½ inch or larger and saturated with water and allowed to dry, remain intact when exposed to water thereafter.

22. The method of claim 21 wherein said composition yields a shore “A” wet hardness of at least about 50.

23. The method of claim 22 wherein said composition yields a shore “A” wet hardness of at least about 60.

24. The method of claim 19 wherein said polyvinyl alcohol is present in an amount of more than about 3 percent by weight of said particulate filler.

25. The method of claim 19 wherein said polyvinyl alcohol is present in an amount of more than about 5 percent by weight of said particulate filler.

26. The method of claim 19 wherein said polyvinyl alcohol is present in an amount of between about 3 and 7 percent by weight of said particulate filler.

27. The method claim of claim 24 wherein said borate salt is present in an amount of between about 10 and 15 percent by weight of said polyvinyl alcohol.

28. The method of claim 19, wherein the borate salt is sodium borate decahydrate.

29. The method of claim 19, wherein the particulate filler is selected from a group consisting of sand and stone dust.

30. The method of claim 19 wherein the polyvinyl alcohol has an average molecular weight between 7,000 daltons and 23,000 daltons.

31. The method of claim 19 wherein the polyvinyl alcohol is between about 87% and about 99% hydrolyzed.

32. The method of claim 19 wherein the polyvinyl alcohol has a viscosity rating between 3.5 and 6.2 centipoises in a 4% solution at 20° C.

33. The method of claim 19 wherein the polyvinyl alcohol has a degree of polymerization between about 150 and about 650.

34. A joint filler composition comprising:
a dry mixture containing at least one particulate filler as-a polyvinyl alcohol in an amount between about 3 and 7 percent by weight of said particulate filler; and
a borate salt in an amount of at least about 10 percent by weight of said polyvinyl alcohol;
wherein the balance of said composition is said particulate filler, and said composition is substantially free of water storage materials and yields a shore A″ wet hardness of at least about 40.

35. A method of filling a joint between paver blocks and/or stone, said method comprising:
forming a composition that comprises at least about 90 wt.% of at least one particulate filler, polyvinyl alcohol in an amount between about 1 and 10 percent by weight of said particulate filler, and a borate salt in an amount of at least about 10 percent by weight of said polyvinyl alcohol, said composition being substantially free of water storage materials;
filling said joint with said composition to a desired level;
saturating said composition in said joint with water, and allowing said water-saturated composition in said joint to harden.

36. The method of claim 35 wherein said joint has a width of at least 1.2 cm.

37. The method of claim 36 wherein said joint has a width of up to 8 cm.

38. The method of claim 35 wherein said composition yields a shore “A” wet hardness of about 40 or higher.

39. The method of claim 38 wherein said composition yields a shore “A” wet hardness of about 60 or higher.

40. The method of claim 35 wherein said polyvinyl alcohol is present in an amount of more than about 3 percent by weight of said particulate filler.

41. The method of claim 40 wherein said polyvinyl alcohol is present in an amount between about 5 and about 7 percent by weight of said particulate filler.

42. The method of claim 35 wherein the borate salt is present in an amount of between about 10 and 15 percent by weight of said polyvinyl alcohol.

43. The method of claim 35 wherein the particulate filler is selected from a group consisting of sand and stone dust.
